(19) United States
(12) Patent Application Publication
(10) Pub. No.: US 2006/0077841 A1
(43) Pub. Date: Apr. 13, 2006

(54) METHOD OF RECORDING DATA ON OPTICAL STORAGE MEDIUM AND APPARATUS THEREOF

(75) Inventors: Li-Lien Lin, Hsinchu City (TW); Wen-Yi Wu, Jhubei City (TW); Wan-Perng Lin, Taipei City (TW)

Correspondence Address: CONNOLLY BOVE LODGE & HUTZ LLP, SUITE 800, 1990 M STREET NW, WASHINGTON, DC, 20036-3425, US

(73) Assignee: MEDIATEK INC., Hsinchu City (TW)

(21) Appl. No.: 11/163,014

(22) Filed: Sep. 30, 2005

(30) Foreign Application Priority Data
Oct. 13, 2004 (TW) 093130983

(51) Int. Cl. G11B 7/00

(52) U.S. Cl. 369/53.2; 369/275.3

(57) ABSTRACT

A method of recording data on an optical storage medium writes different types of data to the same area on the optical storage medium. The data to be written are successively stored in a data buffer in accordance with the sequence of the identification data of a data sector. The same area can be a lead-in area, a data area or a lead-out area. Therefore, a recording circuit can read out the data from the data buffer in accordance with the sequence of corresponding identification data and write them to corresponding tracks on the optical storage medium.

### BACKGROUND OF THE INVENTION

1. Field of the Invention

The present invention relates to a method of recording data on an optical storage medium and apparatus thereof, more particularly to a method of pre-processing different types of data written to the same data sector on an optical storage medium and apparatus thereof.

2. Description of the Related Art

FIG. 1(a) is a schematic diagram of the data structure of a digital versatile disc (DVD). The structure of a DVD 10 comprises, in outward order, a lead-in area (LI) 11, a data area 12, and a lead-out area (LO) 13, with corresponding low-to-high addresses. FIG. 1(b) shows the data structure of the lead-in area 11 which is divided into a reserved zone 111, a reference code zone 112, a buffer zone 1 113, a control data zone 114, and a buffer zone 2 115 wherein all the data recorded in the reserved zone 111, the buffer zone 1 113, and the buffer zone 2 115 are 0. Certainly, the recorded data may be 1 or any other specified value, depending on the format of the DVD 10. The reference code zone 112 records special patterns not produced by software. The control data zone 114 contains related physical data for driving the DVD.

As shown in FIG. 3, the basic unit of the data structure of a DVD is a data sector, and each data sector 30 contains 2048 bytes of main data 31. A 12-byte header is placed in front of the main data 31 and comprises 4 bytes of identification data (ID) 32, 2 bytes of ID error detection code (IED) 33, and 6 bytes of copyright management information (CPR_MAI) 34; 4 bytes of error detection codes (EDC) 35 are added behind the main data 31.

After the header and the error detection code 35 are attached to the main data 31, the 2048-byte data are scrambled in a certain procedure and then the data sector 30 is divided into 12 rows. At this point, the dimensions of the data sector 30 become 12×172 bytes. Afterward, 16scrambled data sectors 41 (192×172 bytes) are combined with each other and subjected to Cross-Interleaved Reed-Solomon Channel Coding, that is, they are concatenated with inner-parity codes 42 (208 rows multiplied by 10 bytes) and outer-parity codes 43 (16 rows multiplied by 172 bytes) to form an error correction code block (ECC block) 40, as shown in FIG. 4. Data encoding entails dividing 16 rows of outer-parity codes 43 evenly and inserting them into every data sector. Meanwhile, the error correction code block becomes composed of 16 record sectors, each with 13 rows multiplied by 182 bytes.

As shown in FIG. 2, all the aforesaid data were temporarily stored in a data buffer 21 of the optical storage device or a DRAM before being written to the DVD 10. The data buffer 21 was divided into a plurality of sub-buffer zones (the first sub-buffer zone through the fourth sub-buffer zone) to store different types of data. In other words, a data buffer controller 22 stores the data to be written to the DVD 10 in various sub-buffer zones according to type. For instance, to write the lead-in area data to the DVD 10, the data to be written to the reserved zone 111, the buffer zone 1 113 and the buffer zone 2 115 are temporarily stored in the first sub-buffer zone, and the data to be written to the reference code zone 112 are temporarily stored in the second sub-buffer zone, and the data to be written to the control data zone 114 are temporarily stored in the second sub-buffer zone. Subject to the sequence of the signals to be written to the DVD 10, an encoder controller 24 retrieves corresponding data from different sub-buffer zones of the data buffer 21 to encode. After the aforesaid data were encoded, a recording circuit 23 retrieves corresponding data from different sub-buffer zones in accordance with the sequence of the signals to be written to the DVD 10, to produce control signals to drive the pick-up head to write on corresponding tracks of the DVD 10. In practice, the encoder controller 24 or any other controller should make a plurality of pointers retrieve corresponding data from different sub-buffer zones in accordance with the sequence of the signals to be written to the DVD 10. For example, the data of the reserved zone are retrieved from the first sub-buffer zone first, the data of the reference code zone are retrieved from the second sub-buffer zone, the data of the buffer zone 1 are retrieved from the first sub-buffer zone, the data of the control data zone are retrieved from the third sub-buffer zone, and finally the data of the buffer zone 2 are retrieved from the first sub-buffer zone. As a result, the disadvantages are as follows:

1. Identification data (ID) of a data sector are not sequentially stored in a data buffer, in the form of indiscrete identification data; instead, they are stored in four different sub-buffer zones according to type. Therefore, at least four pointers are required to encode the aforesaid data. In other words, the encoder controller 24 should control different pointers respectively, hence the complexity of a controlling circuit is increased.

2. To simultaneously encode more different types of data, a data buffer or a memory with larger memory capacity is required to store different types of data temporarily.

### SUMMARY OF THE INVENTION

An objective of the present invention is to provide a method of recording data on an optical storage medium and apparatus thereof wherein different types of data written to the same data sector on the optical storage medium are pre-processed, that is, storing indiscrete identification data (ID) of a data sector in a data buffer or a memory sequentially so that it is feasible to use a simple controlling circuit to read out the indiscrete data sector from the data buffer sequentially and write it to corresponding tracks on the optical storage medium.

Another objective of the present invention is to provide a method of recording data on an optical storage medium to solve the problem of writing different types of data or data from different sources to the same area on the optical storage medium, without using a data buffer or a memory with larger memory capacity to store different types of data temporarily.

To achieve the objectives, the present invention discloses a method of recording data on an optical storage medium and apparatus thereof wherein different types of data to be written to the same area on the optical storage medium are successively and temporarily stored in a data buffer in accordance with the sequence of the identification data of a data sector. The same area can be a lead-in area, a data area or a lead-out area. Therefore, a recording circuit can read out the data from the data buffer in accordance with the sequence of corresponding identification data and write them to corresponding tracks on the optical storage medium.

Before the data are stored in the data buffer, they are combined with the identification data (ID), ID error detection code (IED), copyright management information (CPR_MAI), and error detection code (EDC) corresponding to each data sector; or the identification data (ID), ID error detection code (IED) copyright management information (CPR_MAI), and error detection code (EDC) corresponding to each data sector are given, unless and until the data are sequentially read out from the data buffer.

### BRIEF DESCRIPTION OF THE DRAWINGS

The invention will be described according to the appended drawings in which:

FIG. 1(a) is a schematic diagram of the data structure of a DVD;

FIG. 1(b) shows the data structure of a lead-in area;

FIG. 2 is a block diagram of a conventional optical storage medium recording apparatus;

FIG. 3 shows the data structure of a data sector of a DVD;

FIG. 4 shows the data structure of an error correction code block of a DVD;

FIG. 5 is a block diagram of the optical storage medium recording apparatus in accordance with an embodiment of the present invention; and

FIG. 6 is a schematic circuit diagram of a data pre-processing unit in accordance with the present invention.

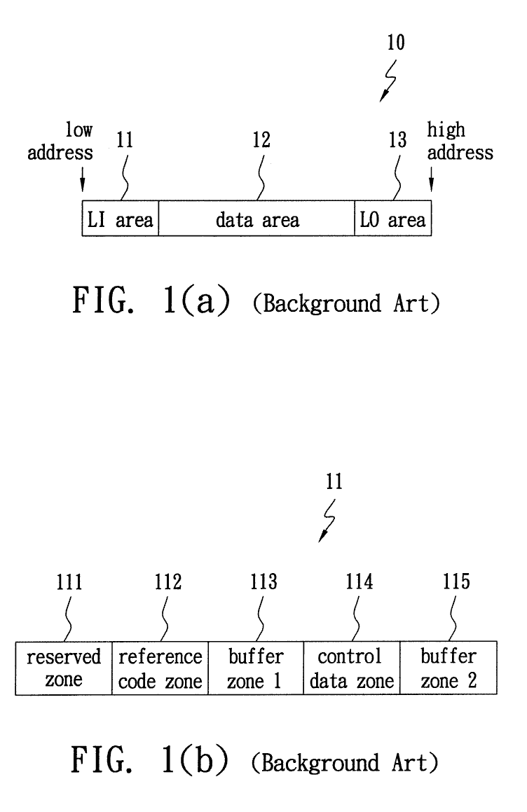

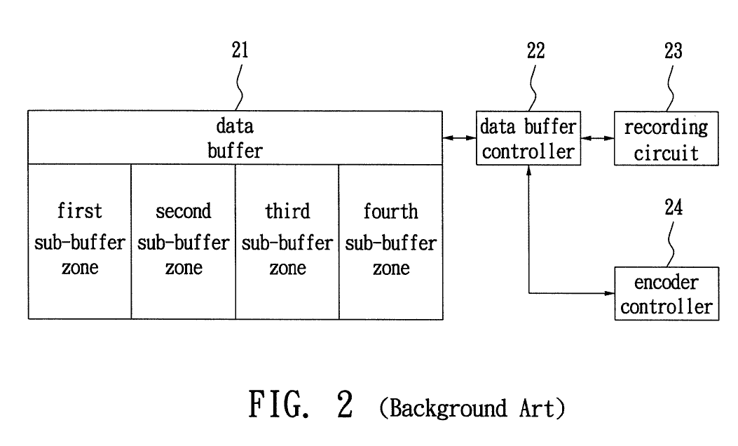

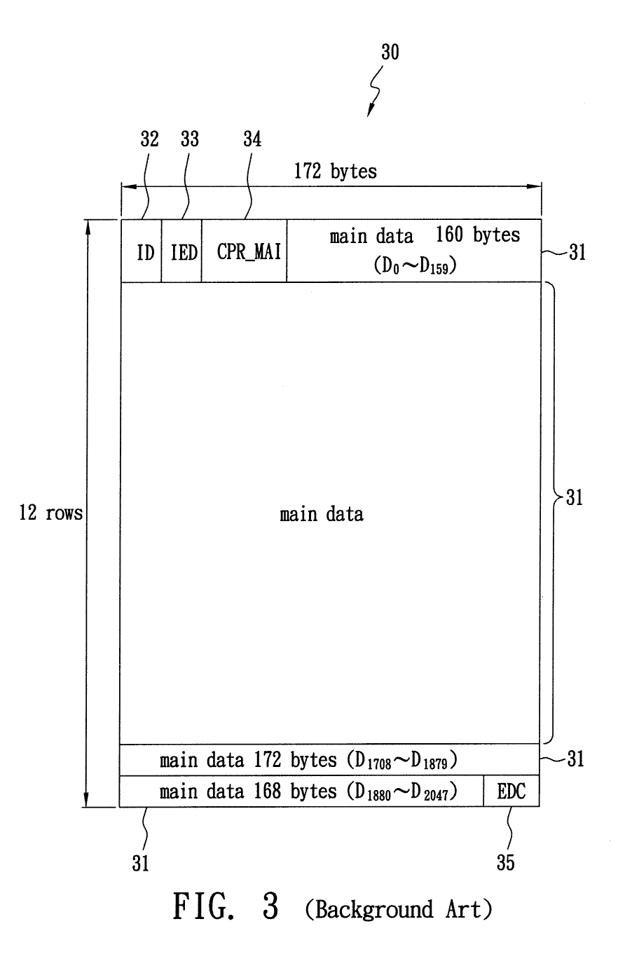

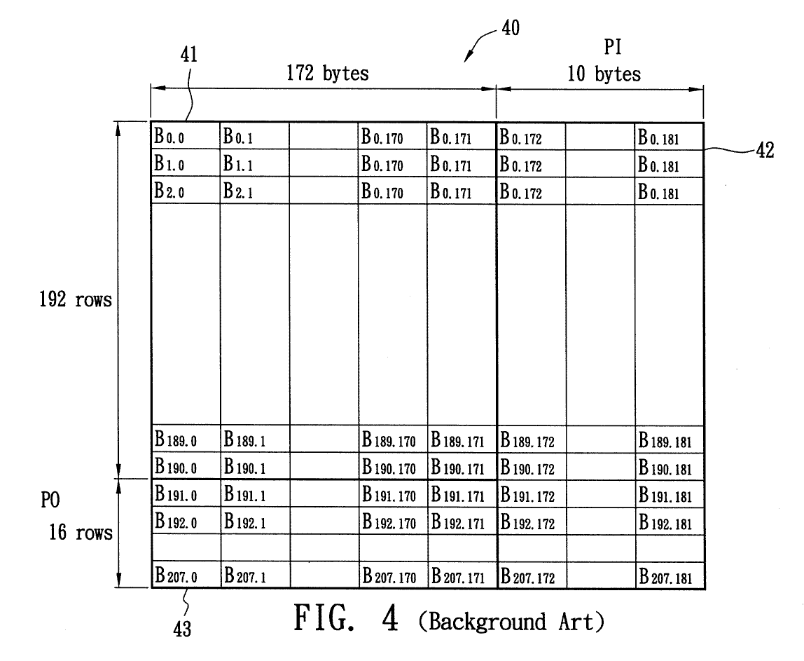

### PREFERRED EMBODIMENT OF THE PRESENT INVENTION

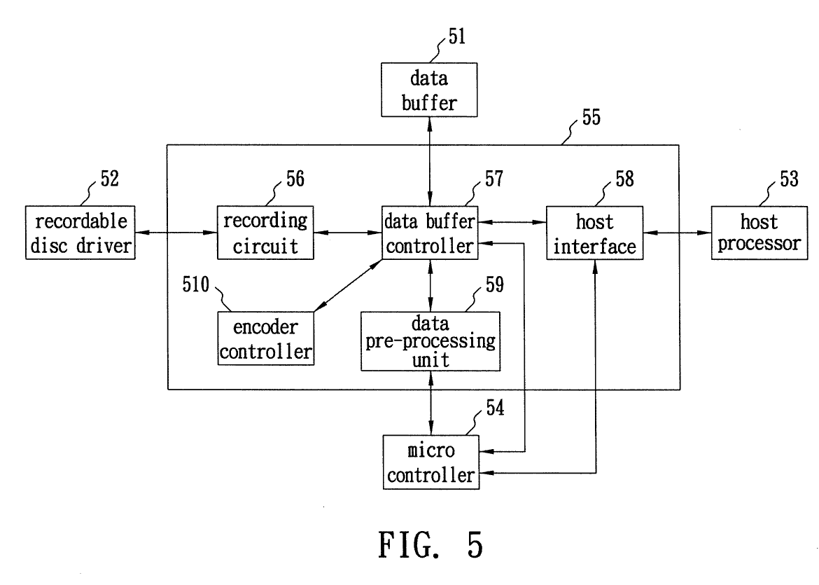

To solve the aforesaid problem of writing data with various types or data from different sources to the same area on an optical storage medium, without increasing memory capacity and the complexity of a controlling circuit, the present invention puts forth improved techniques through the embodiment described below. FIG. 5 is a block diagram of optical storage medium recording apparatus in accordance with an embodiment of the present invention. The recording apparatus 55 can record data signals on a recordable disc, because a recordable disc driver 52 commands the pick-up head of the system to write the data on corresponding tracks. A host interface 58 receives data signals and commands from a host processor 53, usually using a computer standard interface as an interface such as IDE and SCSI.

After a data buffer controller 57 receives commands from the host interface 58, the micro controller 54 sends commands to data pre-processing unit 59 to generate different types of main data and sector header, and buffer to data buffer 51. Afterward, the data processed by the data pre-processing unit 59 are temporarily stored in the data buffer 51 according to the sequence of writing the corresponding data to the disc. An encoder controller 510 sequentially reads the data stored in the data buffer 51 for encoding. A recording circuit 56 sequentially reads the encoded data and sends out commands to control the recordable disc driver 52

In summary, both the aforesaid data structure of a DVD and the block diagram shown in FIG. 5 indicate that data to be written on optical storage media roughly fall into the following four categories.

1. Data produced by a host, for example, those data to be recorded sent out by a computer host through an IDE.

2. Successive bytes of data belonging to an identical matter; for example, the similar data to be recorded on a reserved zone, a buffer zone 1 or a buffer zone 2.

3. Data read from a data buffer, for example, the control data to be written to a control data zone.

4. Data including special patterns, for example, the data to be written to a reference code zone.

With the density and performance of optical storage media increasing, data classification is becoming more complex and excessive. Hence, application of the present invention is not restricted by the aforesaid classification. On the other hand, while the embodiment mentioned below is mainly applied to the processing of data to be written to a lead-in area, data may be written to a program area and a lead-out area under the same principle.

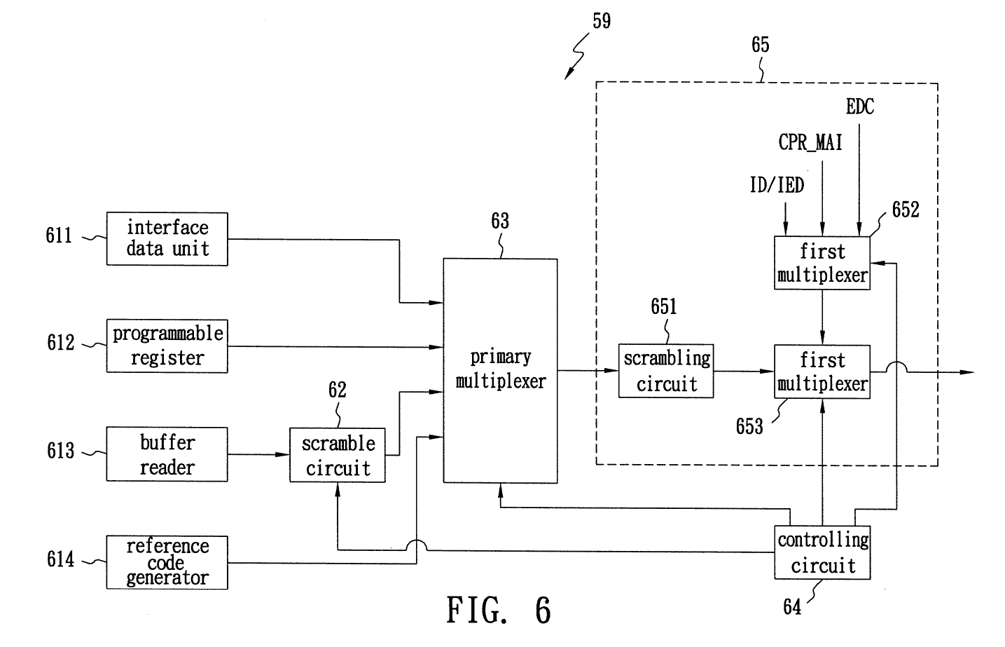

FIG. 6 is a schematic diagram of the circuit for the data pre-processing unit 59 in accordance with the present invention. The data pre-processing unit 59 comprises four data prepare unit, namely an interface data unit 611, a programmable register 612, a buffer reader 613, and a reference code generator 614, corresponding to the aforesaid four types of data respectively. The prepared data output from these four data prepare unit will send to a primary multiplexer 63, which is controlled by a controlling circuit 64. The controlling circuit 64 determines the sequence and the length of each output data according to the mp command. To prepare data from buffer reader 613, a scramble circuit 62 can be used to generate scrambled data if needed. Furthermore, the data received by the interface data unit 611 originate from computer hardware and thus are quite different from the other three types of data in terms of their attributes; hence, they may be processed by an independent (primary) multiplexer.

It is possible that data restructured by the primary multiplexer 63 are realigned according to the sequence of the identification data of a data sector. Information, such as the identification data (ID), ID error detection code (IED), copyright management information (CPR_MAI), and error detection code (EDC) corresponding to each data sector, are inserted into the realigned data again through a sector information labeling circuit 65. However, the information codes for a data sector are not necessarily added immediately after the processing operation of the primary multiplexer 63; or, in other words, data processed by the primary multiplexer 63 can be temporarily stored in the data buffer 51, sequentially read only when recording is required, and given the information codes corresponding to each data sector. Data restructured by the primary multiplexer 63 should be scrambled by a scrambling circuit 651 before they are combined with the information codes through the first multiplexer 652 and the second multiplexer 653, and then the second multiplexer 653 sends the completely processed data to the data buffer controller 57. In addition, the controlling circuit 64 controls the timing at the input ends of the first multiplexer 652 and the second multiplexer 653.

The above-described embodiments of the present invention are intended to be illustrative only. Numerous alternative embodiments may be devised by persons skilled in the art without departing from the scope of the following claims.

What is claimed as new and desired to be protected by Letters Patent of the United States is:

1. A method of recording data on an optical storage medium, comprising the steps of:
storing different types of data successively temporarily in a data buffer according to the sequence of identification data before the data are written to an optical storage medium; and
writing the data stored in the data buffer to corresponding tracks on the optical storage medium after the data are encoded.

2. The method of recording data on an optical storage medium of claim 1, further comprising the step of inserting information codes corresponding to each data sector into the data which are restructured before the data are stored in the data buffer.

3. The method of recording data on an optical storage medium of claim 2, wherein the information codes include identification data (ID), ID error detection codes (IED), copyright management information (CPR_MAI) and error detection codes (EDC).

4. The method of recording data on an optical storage medium of claim 1, further comprising the step of inserting information codes corresponding to each data sector into the data which are restructured after the data are read from the data buffer.

5. The method of recording data on an optical storage medium of claim 4, wherein the information codes include ID, IED, CPR_MAI and EDC.

6. The method of recording data on an optical storage medium of claim 1, wherein the data include data generated by a computer host, data which successive bytes belong to an identical matter, control data read from the data buffer and data with special patterns.

7. The method of recording data on an optical storage medium of claim 6, wherein the data which successive bytes belong to the identical matter will be recorded on a reserved zone, a buffer zone 1 or a buffer zone 2.

8. The method of recording data on an optical storage medium of claim 6, wherein the control data stored in the data buffer will be written to a control data zone on the optical storage medium.

9. The method of recording data on an optical storage medium of claim 6, wherein the data with special patterns will be written to a reserved zone on the optical storage medium.

10. An apparatus for recording data on an optical storage medium, comprising:
a data pre-processing unit restructuring different types of data to be written to identical data sectors on an optical storage medium according to the sequence of identification data (ID) for each data sector;
a data buffer controller storing the restructured data into a data buffer;
a encoder controller reading the restructured data from the data buffer through the data buffer controller and encoding the restructured data; and
a recording circuit successively reading the restructured data from the data buffer through the data buffer controller and writing the restructured data to corresponding tracks of the optical storage medium.

11. The apparatus for recording data on an optical storage medium of claim 10, wherein the data pre-processing unit includes:
a primary multiplexer interlacing the different type of the data; and
a controlling circuit enabling the primary multiplexer to choose one type of the data.

12. The apparatus for recording data on an optical storage medium of claim 11, further comprising:
a scrambling circuit scrambling output signals from the primary multiplexer;
a first multiplexer interlacing information codes corresponding to each data sector; and
a second multiplexer interlacing the output signals from both of the scrambling circuit and the first multiplexer.

13. The apparatus for recording data on an optical storage medium of claim 12, wherein the controlling circuit controls the enabling timing of the first multiplexer and the second multiplexer.

14. The apparatus for recording data on an optical storage medium of claim 12, wherein the information codes include ID, IED, CPR_MAI and EDC.

15. The apparatus for recording data on an optical storage medium of claim 12, wherein the different types of the data interlaced by the primary multiplexer include data generated by a computer host, data which successive bytes belong to an identical matter, control data read from the data buffer and data with special patterns.

16. The apparatus for recording data on an optical storage medium of claim 15, wherein the data whose successive bytes belong to identical matter will be recorded on a reserved zone, a buffer zone 1 or a buffer zone 2.

17. The apparatus for recording data on an optical storage medium of claim 15, wherein the control data stored in the data buffer will be written to a control data zone on the optical storage medium.

18. The apparatus for recording data on an optical storage medium of claim 15, wherein the data with special patterns will be written to a reserved zone on the optical storage medium.
